(19) United States
(12) Patent Application Publication
(10) Pub. No.: US 2005/0117620 A1
(43) Pub. Date: Jun. 2, 2005

(54) High peak power laser cavity and assembly of several such cavities

(76) Inventors: Pierre-Yves Thro, Gif-Sur Yvette (FR); Jean-Marc Weulersse, Palaiseau (FR); Michel Gilbert, Bures Sur Yvette (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/505,164

(22) PCT Filed: Mar. 26, 2003
(86) PCT No.: PCT/FR03/00956

(30) Foreign Application Priority Data
Mar. 28, 2002 (FR) 0203964

(51) Int. Cl. H01S 3/091; H01S 3/14

(52) U.S. Cl. 372/70; 372/68

(57) ABSTRACT

A high peak power optical rest and combination of plural of the resonators, particularly to excite a light generator in the extreme ultraviolet. An optical resonator with a solid state amplifying medium is pulsed and pumped by diodes operating continuously. The optical resonator includes at least two laser rods, at least one mechanism to trigger optical pulses, the triggering mechanism located in a part of a cavity in which the laser beam diverges least, and first and second mirrors that delimit the cavity, the first mirror being highly reflecting and the second mirror being partly reflecting.

### TECHNICAL DOMAIN

This invention relates to a high peak power optical resonator with a high mean power and a high recurrence rate, with minimum cost and complexity. It also relates to the combination of several of these resonators, particularly to excite a light generator in the extreme ultraviolet.

The invention is thus more particularly applicable to light generation in the extreme ultraviolet range.

Radiation within this range that is also called “EUV radiation” has wavelengths varying from 8 nanometres to 25 nanometres.

EUV radiation that can be obtained by making light pulses generated with the device according to the invention interact with an appropriate target has many applications, particularly in the science of materials, microscopy and more particularly microlithography to make very large scale integrated circuits. For very large-scale integrated circuits, it is particularly advantageous to have a high recurrence rate, which is very difficult to obtain for high peak power lasers.

The invention is applicable to any domain that requires an excitation laser of the type necessary in microlithography.

### STATE OF PRIOR ART

EUV lithography is necessary in microelectronics to make integrated circuits with dimensions of less than 0.1 micrometers. Several sources of the EUV radiation use a plasma generated using a laser.

In particular, it is required to generate ultraviolet radiation with a wavelength equal to about 13 nm by exciting a xenon jet with an intense laser source.

Three conditions must be combined for this laser source to be economically satisfactory:
the peak power of the laser light must be very high (of the order of 10¹¹ W/cm²) in order to create a sufficiently emissive plasma around 13 nm,
the repetition rate must be high (several kilohertz) to make as many semiconductor wafers as possible per hour, and
the laser source must be simple, it must have a reasonable investment cost and a low operating cost.

Therefore, a laser generating a high peak illumination must be available to create the plasma.

This is done using a pulse laser, for example outputting an energy of the order of 300 mJ per pulse or more.

Note that the invention can for example make use of YAG lasers doped with neodyme, and many developments have been made in many industrial fields for these lasers. However, other solid-state lasers, in other words lasers for which the amplifying medium is solid, can be used in this invention.

We will discuss this point in more detail later.

It is known how to use pumping by laser diodes in order to obtain a very good energy stability in each firing.

Furthermore, it is known how to use pulse diodes to obtain the peak power necessary for generation of EUV radiation to be used for photolithography.

The following document provides further information about this subject:

[1] Article by H. Rieger et al., High brightness and power Nd:YAG laser, Advanced solid-state lasers, 1999, Boston Mass., p. 49 to 53.

This document divulges a device for photolithography, generating high peak amplitude laser pulses at a relatively low recurrence rate.

It is also known how to use an oscillator and amplifiers to obtain the necessary peak power. This results in a complex and expensive laser.

The following document provides further information about this subject:

[2] Article by G. Holleman et al., Modeling high brightness kW solid-state lasers, SPIE Vol. 2989, p. 15 to 22.

This document mentions two needs for power lasers corresponding to two opposite technologies:
firstly, welding, machining and material treatment applications that require lasers emitting long pulses obtained by very simple technologies and,
secondly, photolithography applications that require short pulses at a high rate if possible, obtained by a very sophisticated and expensive technology, in particular using two optical amplification stages.

Refer also to the following document, that describes a high peak power laser device:

[3] Article by G. Kubiak et al., Scale-up of a cluster jet laser plasma source for extreme Ultraviolet lithography, SPIE Vol. 3676, p. 669 to 678.

The device described in this document [3] uses YAG lasers doped with noedyme, pumped by pulsed diodes as in the rest of prior art related to photolithography. It also uses complex and expensive optical amplifiers. Furthermore, the target recurrent rate in this document [3] is 6 kHz, for a pulse energy of 280 mJ.

An improved version of this laser is described in document [6] discussed below.

Refer also to the following document:

[4] Article by H. Rieger et al., High brightness and power Nd:YAG Laser, OSA trends in Optics and Photonics, Vol. 26, from the topical Meeting Jan. 31, Feb. 3, 1999 in Boston, Optical Society of America, p. 49 to 53.
which briefly describes a device with a very low power master oscillator outputting 1 mJ pulses at a maximum frequency of 1 kHz (therefore with an average power equal to not more than 1 W), followed by a complex and expensive amplification system. The essential part of this document consists of studying the degradation of the quality of the beam in this amplification system. The device described has performances well below the performances required for an EUV source to be used in microlithography, both in terms of the average power and of the repetition frequency.

The characteristics required for a laser device that could excite an intense EUV radiation source compatible with the needs of the semiconductors industry have been standardised on a world scale in the form of a specification, and many attempts have been made to satisfy this specification.

However, up to now, all these attempts have failed.

The strict constraints in the specification obviously include the ability to generate high peak intensities with a very high recurrence rate. But there is also the need to obtain a good quality beam, characterised by the lowest possible value of the magnitude M² that is defined as being the product of the beam diameter, and the angle of its divergence and a constant.

The theoretical lower limit of M² is equal to 1, but as the laser power increases, the value of M² increases. It typically reaches several tens with a YAG laser doped with neodyme, also called an Nd:YAG laser.

The specification mentioned above imposes M²≦10.

Other more recent documents divulge devices intended to satisfy this specification:

[5] Article by K. Nicklaus et al., Industry-Laser Based Short Pulse Diode Pumped Solid State Power Amplifier With kW Average Power, OSA Trends in Optics and Photonics, Vol. 50, Advanced Solid-State Lasers, Christopher Marshall, ed., Optical Society of America, 2001, p. 388 to 391,
which describes a device in which the optical resonator outputs 4 mJ pulses at 2 kHz (or 8 mJ pulses at 1 kHz) to a set of two double passage preamplifiers. The return path of the beam is deflected by a polarising cube to a line of two amplifiers, whose output delivers 76 mJ (the structure of such a device is called a MOPA: Master Oscillator Power Amplifier).

[6] Article by D. A. Tichenor et al., EUV Engineering Test Stand, Emerging Lithographic Technologies IV, Elisabeth A., Dobisz, Editor, Proceedings of SPIE Vol. 3997 (2000), p. 48 to 69.

This article describes a laser installation using three identical modules put in parallel, each of these modules being composed of the laser made by the TRW Company and described in the following document:

[7] Active Tracker Laser (ATLAS), Randall St. Pierre et al., OSA TOPS, Vol. 10, Advanced Solid State Lasers, 1997, p. 288 to 291.

The Nd:YAG solid-state optical resonator described in document [7] outputs pulses of 1.6 mJ at 2.5 kHz, which are amplified in a double pass structure producing output pulses of 276 mJ. A slightly earlier version of this TRW laser was described in document [3].

According to documents [5] and [6], light pulses are generated in a basic laser containing a very small low energy oscillator (less than 10 mJ per pulse) with low average power (less than 15 W), and they are amplified by many passes in rod or plate amplifier stages, in order to obtain a high power with a low value of M² and very short pulses.

The problem then arises that when the incident light power is low compared with the saturation fluence of the laser rod used (and particularly for incident fluences less than 200 mJ/cm² for the Nd:YAG), the amplification provided by the rod is very weak. A large number of amplifying rods which are extremely expensive are then necessary, together with several tens of diodes which are also very expensive, and the energy efficiency of the final result is very low.

In order to limit the installation cost, there are usually two passes through the first stage(s) (forward-return path, which is why it is called the double pass amplifier), which makes it necessary to work with a polarised beam and to use a polariser (for example a polariser cube) so that the return path does not return onto the oscillator but is switched along another optical path, along which the amplification will be continued.

This need to polarise the beam introduces an additional problem in the case in which the double pass amplification uses an isotropic material for example such as the Nd:YAG or the Yb:YAG, as the amplifying rod. The isotropy of this type of material is modified at the time of pumping, which degrades the polarisation of the incident beam.

Thus, if complex devices were not installed to limit this phenomenon, polarisation would not be sufficiently maintained and a large part of the beam energy (about 25% for Nd:YAG) would be lost when the return beam entered the polariser, and this could destroy the oscillator.

These complex devices, in other words essentially associations of polarisation rotators and judiciously placed phase plates, limit the power of the beam returning to the oscillator to a low value (about 2.4% for Nd:YAG).

Thus, in order to solve the problem of obtaining a laser device capable of exciting an intense EUV radiation source compatible with the needs of the semiconductors industry, the authors of document [5] and also the authors of documents [6] and [7] generated the most perfect possible pulses with very low power, and then multiplied the number of amplifiers and concentrated all their efforts on research for means to limit depolarisation losses in these amplifiers.

This method leads to complex and expensive devices with a low energy efficiency. Furthermore, for the devices described in documents [5] and [7], the main elements were placed in series. Thus, any failure of either of them will affect the entire device.

Another method was proposed in the following document:

[8] Compact 300-W diode-pumped oscillator with 500 kW pulse peak power and external frequency doubling, Oliver Melh et al., OSA trends in Optics and Photonics (TOPS), Vol. 56, Conference on Lasers and Electro-Optics (CLEO 2001, May 6-11 2001, Technical Digest, pp. 421-422.

This document describes an Nd:YAG laser comprising two Nd:YAG rods, a polarisation rotator between these rods, two acousto-optical modulators one on each side of the two rods and a divergent lens between each modulator and the corresponding rod, all within an optical resonator.

The average output power of the optical resonator is 260 W, and the recurrence rate is 10 kHz.

However, the implementation described in this document ignores an important problem related to light pulse triggering (Q-switching) devices, particularly acousto-optical Q-switch devices used in the laser described in this document; the problem is that their operation depends on the divergence of the laser beam.

Acousto-optic triggers (Q-switches) essentially comprise an acousto-optic crystal and a control device and operate as follows:

When it receives an electrical signal, the control device emits a radio frequency excitation wave in the crystal, which generates a Bragg grating in this crystal. When there is no excitation, this crystal allows incident rays to pass, which under nominal operating conditions do not arrive along the normal to the entry face of the crystal, but make a Bragg angle with it.

When the control is activated, the radio frequency wave generates the Bragg grating that then deflects the incident light rays; the deflection angle is sufficient so that these rays leave the optical resonator, which corresponds to cutting off the beam laser.

When light rays arrive on the entry face to the crystal at an angle not equal to the Bragg angle, they are no longer suitably deflected, particularly if they shift by an angle close to a limiting or critical angle, or greater than this limiting angle.

The value of this limiting angle is practically the same as the value of the angle between the directions of the first and second order beams diffracted by the Bragg grating formed in this crystal when it is excited (typically about 4 mrad).

Rays with an angle of incidence close to this angle are not correctly intercepted when the crystal is excited. Rays for which the incidence exceeds this angle are no longer suitably deflected, but also they return towards the central part of the optical resonator since their incidence is within the angular acceptance of this cavity.

They then make the cavity emit in an unwanted manner, which generates emission of some continuous laser light power at the output. Operation becomes erratic, and pulses with an unstable amplitude and duration superpose on this continuous laser emission at the output from the resonator.

For the same beam divergence, the instability increases as the pulse power required from the cavity increases.

### PRESENTATION OF THE INVENTION

The purpose of this invention is to solve the problems inherent to MOPA structures used in embodiments described in documents [5] to [7] and problems inherent to structures with an oscillator outputting a high power but for which the stability is affected by limitations to acousto-optical triggers (Q-switches), as in the embodiment described in document [8].

The invention is intended to solve them using an optical resonator with a high peak power and high recurrence rate, and by the association of this cavity with other identical cavities to form a laser device to achieve higher peak power performances than are possible with devices disclosed by documents [5] to [8], while being less complex, less expensive and with more reliable operation.

Note also that the laser devices disclosed by document [5] are designed to obtain short duration pulses from 5 ns to 20 ns, which persons skilled in the art consider as being favourable to obtaining a very emissive plasma.

Specifically, the purpose of this invention is an optical resonator with a solid state amplifying medium, this optical resonator being pulsed and pumped by diodes operating continuously, and characterised in that it comprises:
at least two laser rods,
at least one means of triggering light pulses, this triggering means being located in the part of the resonator in which the laser beam generated by the resonator diverges least, and
two mirrors that delimit this resonator, one being highly reflecting and the other being partly reflecting.

In the simplest case of a resonator with two laser rods, the part of the resonator in which the laser diverges least is the part located between the two rods.

At the opposite side, the parts of the resonator located outside the rods between one of the rods and one of the mirrors of the resonator, are the parts in which the beam diverges most.

The implementation described in document [8] places the light pulse triggering means in these parts, which makes them subject to the dysfunctions described for the state of prior art.

If the laser rods are made from an isotropic material such as Nd:YAG or Yb:YAG, it is necessary to add a polarisation rotation means on the path of the beam in each of the spaces formed by two successive rods, this rotation preferably being 90°, in order to obtain the beam quality specified for the microlithography industry.

Advantageously, the slight convergence produced by some laser rods, and particularly Nd YAG, is corrected by placing, on the beam path, a lens with an opposite effect on convergence, in the middle of each interval between two adjacent rods.

According to one preferred embodiment of the device according to the invention, the laser material from which the laser rods are made is chosen in the group comprising Nd YAG, Nd:YLF, Nd:YALO, Yb YAG, Nd:ScO₃ and Yb:Y₂O₃.

Preferably, the resonator according to the invention comprises two rods made of a laser material, preferably substantially identical, polarisation rotation means placed in the resonator between these two rods, and two means of triggering pulses placed between the two rods on each side of the polarisation rotation means.

Preferably, the triggering means are of the acousto-optical type.

According to one variant embodiment, the optical resonator according the invention could be associated with one or several single pass laser amplifiers pumped by diodes, the rod for each amplifier being activated over its entire length at or above the saturation fluence of the rod material.

Preferably, this fluence is equal to at least three times the material saturation fluence.

Functionally, the optical resonator is characterised by its capability of producing a stable output with a high fluence without it being necessary to make the beam that it generates converge. It can keep the parallelism of this beam and reach or exceed this saturation fluence over the entire length of the rod.

In the preferred application that will be described in detail later, this fluence is equal to about ten times the material saturation fluence.

The invention also relates to the association of at least three optical resonators of the type described above, arranged in parallel but for which the beams that they generates are directed towards the same target.

The laser device resulting from this combination of these cavities is characterised in that it comprises:
at least three pulsed optical resonators with a solid state amplifying medium, these resonators complying with the optical resonator according to the invention, and
means for transferring these light pulses to substantially the same location on a target and at substantially the same time at this location,
and in that the device also comprises means of controlling the pulsed optical resonators, these control means being designed so that all pulses reach the target at practically the required instant with a precision better than 5 ns, and preferably better than 1 ns.

According to one variant, the optical resonators are associated with one or several single pass amplifiers.

According to a particular embodiment of the device according to the invention, the triggering means for each pulsed optical resonator comprise two triggers (Q-switches) placed in this resonator, on each side of the polarisation rotation means, between these means and the rods made of a laser material.

According to one particular embodiment of the invention, the means of sending light pulses comprise means of sending these light pulses onto the target along the same path.

According to one particular embodiment of the device according to the invention, this device also comprises means of modifying the spatial distribution of the light pulse resulting from the addition of light pulses output by the optical resonators.

According to another particular embodiment, the means of controlling the optical resonators are also capable of modifying the time distribution of the light pulse resulting from the addition of light pulses supplied by the optical resonators, in order to create composite pulses.

According to one particular embodiment of the invention, the profile of each composite pulse comprises a first plasma ignition pulse that will be created by interaction of the light pulses with the target, a time interval in which the light energy output by the laser is minimum during plasma growth, and then a second pulse composed of several elementary pulses according to a sequence that depends on plasma growth.

If composite pulses are created, the device according to the invention is preferably capable of sending a first highly focused beam onto the target, and then applying the remainder of the light energy onto the target with broader focusing.

The target on which light pulses emitted by the optical resonators in the device according to the invention are emitted, may be designed to output light in the extreme ultraviolet domain by interaction with these light pulses.

However, this invention is not limited to obtaining EUV radiation. It is applicable to any domain in which high peak power laser beams directed onto a target are necessary.

A spatial superposition is used in this invention, and in a particular embodiment a time sequence is used.

“Spatial superposition” means superposition of a plurality of laser beams substantially at the same location of the target, and substantially at the same time.

“Substantially at the same time” means that the time differences between the various elementary pulses supplied by the different optical resonators in the laser device are small compared with the recurrence period of these optical resonators. This superposition makes it possible to multiply the energy per pulse and peak powers.

As will be seen later, versatility can be obtained with superposition of the laser beams at almost the same location and almost the same time. This versatility makes it possible for the resulting laser beam to be adapted to requirements of the plasma.

In this invention, points (a) to (c) described below are important.

a) Spatial Superposition

Spatial superposition increases the peak power and gives broad freedom to modify the spatial distribution of the light pulse resulting from the addition of the elementary light pulses emitted by the optical resonators.

For example, the use of one light pulse more focused than the others as implemented in one preferred embodiment of the invention, can give a greater local illumination as shown diagrammatically in FIGS. 1 and 2, in which only two beams are shown to simplify the drawings.

A first light beam F1 and a second light beam F2 are shown in a sectional view in FIG. 1, in a plane defined by two perpendicular axes Ox and Oy, the axis common to the two beams being the Oy axis.

The two beams have approximately the same symmetry of revolution about this Oy axis and are focused close to the point O, substantially in the observation plane defined by the Oy axis and by an axis perpendicular to the Ox and Oy axes and that passes through the point O.

The focussings of the two beams are different, the first beam F1 being more tightly focused than the second beam F2.

FIG. 2 shows variations of the illumination I in the observation plane as a function of the abscissa x along the Ox axis.

If beam F1 is five times more focused than beam F2, the illumination produced by this beam F1 on the Oy axis is twenty five times greater than the illumination produced by the beam F1 when the two beams have the same power. But note that with this invention, beams with identical powers could be used, or on the other hand the beams could have different powers or very different powers from each other.

This “spatial superposition” with several beams on the same target at the same time enables an offset of the times of pulses of each elementary optical resonator, on a smaller time scale.
b) Sequencing in Time of the Different Laser Pulses (“Composite” Pulses)

Pulse bursts can be created in which time offsets between two pulses from two elementary optical resonators are very small compared with the recurrence time between two bursts. These types of bursts may be considered as being composite pulses.

A prepulse may also be created by a time offset of these light pulses.

Further information about this subject is given in the following document that mentions the possibility of creating a charged prepulse for ignition of the plasma:

[9] Article by M. Berglund et al., Ultraviolet prepulse for enhanced X-ray emission and brightness from droplet-target laser plasma, Applied Physics Letters, vol. 69, 1996, page 1683.

The invention preferably uses this sequence in time for the various laser pulses.

For example, it can be used to obtain the sequencing described below.

A first pulse highly focused on the target (for example this pulse being of the type of beam F1 in FIG. 1) ignites a plasma, and then while the plasma is growing, the target is subjected to minimum or zero illumination, and when the plasma reaches the diameter of the beam F2, a maximum light power is applied to the target. It is then advantageous if the energy dedicated to the first pulse is lower than the energy dedicated to the remainder of the composite pulse as shown in FIG. 3.

In FIG. 3, the amplitudes A of the light pulses are shown as a function of time t. It shows an example of a composite pulse 11. This composite pulse comprises a prepulse 12 followed by a first set of simultaneous elementary pulses 13, separated from the prepulse by a time T necessary for growth of the plasma, and then a second set of elementary simultaneous pulses 14 following the first set.
c) Use of Continuous Diodes for Pumping the Laser Material

If an optical resonator using a YAG material doped with neodyme is used with continuous pumping, the life of the upper level of the optical resonator that is close to 250 microseconds makes it necessary to work at a rate of more than 5 kHz to actually extract the deposited light power.

Unlike prior art, this invention can be used to obtain high peak powers, by associating an unfavourable point for this peak power (point c) and a favourable point (point a) with a weight that becomes greater as the number of elementary optical resonators is increased.

Point (b) is simply one possible way of adapting the invention to its applications as well as possible.

For an application to microlithography, this possibility enables the behaviour of the EUV source pumped by the laser device to be optimised to suit other plasma requirements.

However, in the current state of the art, it is considered preferable to make all pulses arrive at the same time, within 5 ns, or even better within 1 ns.

In this invention, points (a), (b) and (c) can all be used at the same time, and this combination of favourable and unfavourable points for obtaining high peak powers is contrary to prior art.

Advantages of this invention, apart from the generation of high power and high speed laser pulses, are described below.

The cost of diodes, for a constant mean power, is significantly lower if these diodes operate continuously.

Furthermore, a laser device according to the invention may be much simpler than a laser device according to prior art because this device can operate without putting amplifiers in series.

The operation and maintenance of this laser device is less expensive due to the small number of optical components used.

Greater usage flexibility is possible due to the fact that several oscillators are put in parallel.

The increase in the number of optical resonators also makes the device according to the invention less sensitive to an incident affecting the instantaneous performances of one of the optical resonators.

### BRIEF DESCRIPTION OF THE FIGURES

This invention will be better understood after reading the following description of example embodiments given purely for information and which in no way is limitative, with reference to the attached drawings in which:

FIGS. 1 and 2 diagrammatically illustrate the use of two laser beams focused differently to locally obtain high illumination, and have already been described,

FIG. 3 diagrammatically illustrates an example of a composite light pulse that can be used in this invention and that has already been described,

FIG. 4 is a diagrammatic view of a combination of several optical resonators according to the invention in order to create an excitation device for a light source in the extreme ultraviolet,

FIG. 5 diagrammatically illustrates a particular embodiment of the optical resonator according to the invention, and

FIGS. 6 and 7 diagrammatically and partially illustrate other examples of the invention, enabling spatial multiplexing of elementary laser beams generated individually by several optical resonators.

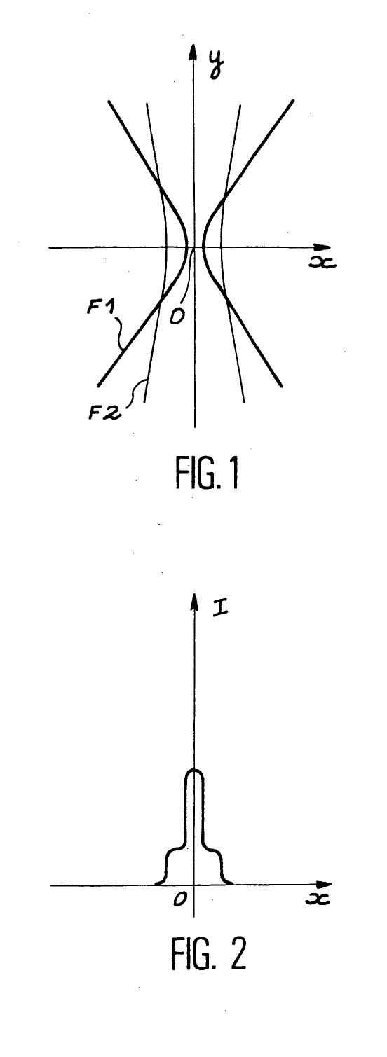

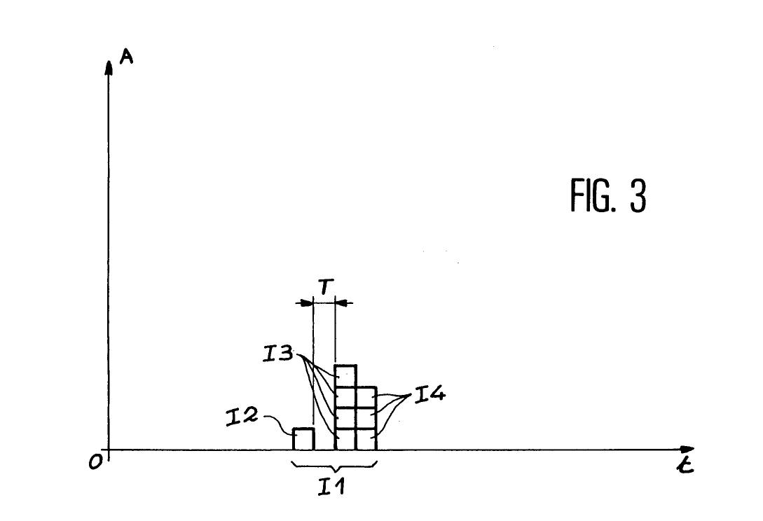

### DETAILED DESCRIPTION OF PARTICULAR EMBODIMENTS

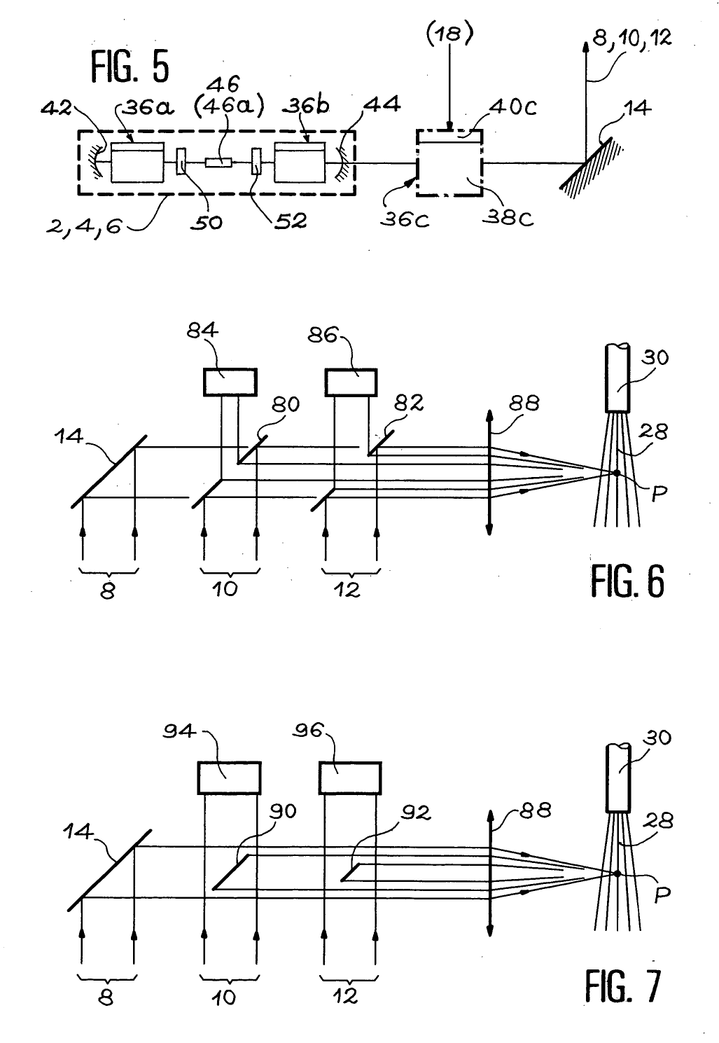

An optical resonator conform with the invention is shown in FIG. 5, and will be described in more detail later. It may be followed by one or several single pass amplifiers.

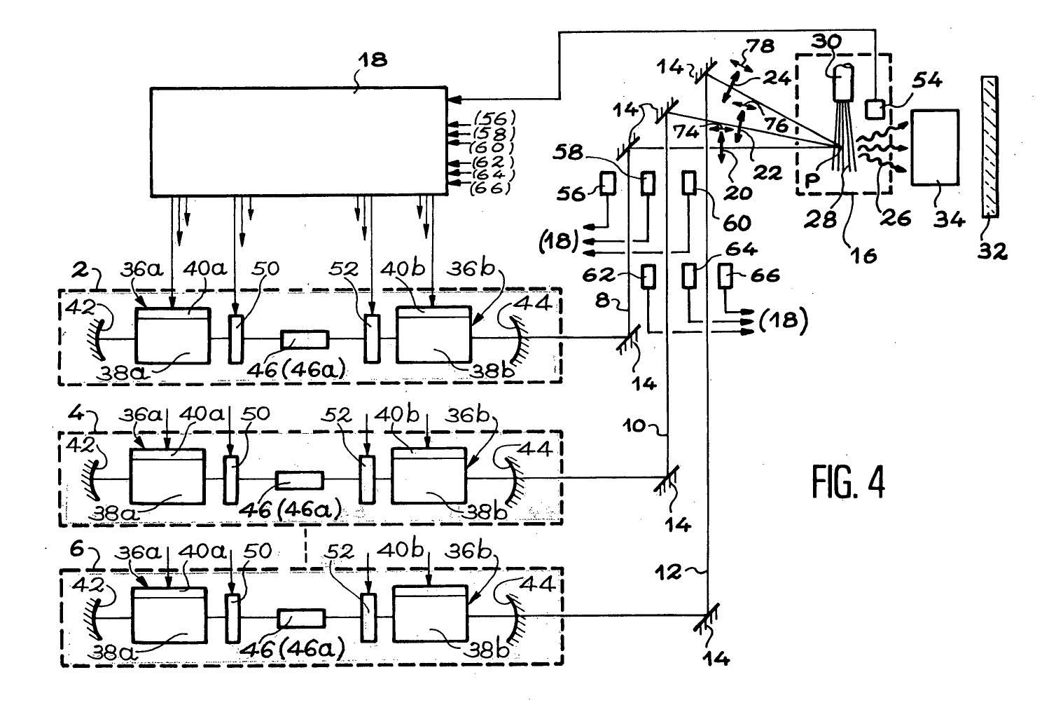

The combination of several pulsed optical resonators according to the invention in order to create an excitation device for a light source in the extreme ultraviolet is shown diagrammatically in FIG. 4.

The device in FIG. 4 comprises more than three pulsed optical resonators, that are also called pulsed lasers, for example ten, but only three of them are shown in this FIG. 4 and their reference numbers are 2, 4 and 6 respectively.

The light beams 8, 10 and 12 (more precisely the light pulses) supplied by these pulsed optical resonators 2, 4 and 6 were sent through a set of mirrors 14 to approximately the same point P on a target 16 and arriving at this point P at approximately the same time.

Laser control means 18 are also shown, capable of obtaining laser pulses.

FIG. 4 also shows focusing means 20, 22 and 24, that for example are achromatic doublets designed to focus light beams 8, 10 and 12 respectively on point P of the target 16.

In the example considered, the lasers and the target are chosen to output an EUV radiation 26 by interaction of the light beams with this target. In order to do this, the target includes for example an aggregate jet 28 (for example xenon) output from a nozzle 30.

For example this EUV radiation 26 may be used for microlithography of an integrated circuit 32. The block 34 in FIG. 4 symbolises the various optical means used to shape the EUV radiation before it reaches the integrated circuit 32.

Lasers 2, 4 and 6 are identical or almost identical and are capable of supplying light pulses.

Each laser comprises two pumping structures 36a and 36b, for which the aberration and birefringence are low.

The structure 36a comprises a laser rod 38a pumped by a set of laser diodes 40a, and the structure 36b comprises a laser rod 38b pumped by a set of laser diodes 40b, operating continuously.

The material chosen for our experiments is Nd:YAG, for which the saturation fluence is 200 mJ/cm²;

However, it may be advantageous to choose a different laser from the others to create the first pulse called the prepulse.

Each optical resonator directly produces a power of 300 W at 10 kHz, with a beam quality compatible with multiplexing, the pulse duration being 50 ns and its energy being 300 mJ. The fluence of the beam at the exit from the cavity is 2.3 J/cm², which is almost ten times the saturation fluence of the Nd:YAG material.

The focusing of the beam produced by each laser 2, 4 and 6 on a 50 μm diameter area of the target then leads to a peak power of 3×10¹⁰ W/cm² to 6×10¹⁰ W/cm².

A value of 5×10¹¹ W/cm² is a typical target value to be achieved, in order to obtain sufficient emissivity on a liquid xenon target.

Therefore, this is obtained by combining ten lasers with the performances mentioned above.

No light amplifier is used with lasers 2, 4 and 6 in the example in FIG. 4.

However, it would be possible to add such an amplifier or even several such amplifiers after each optical resonator, if this is found to be necessary to adjust the peak power to an optimum determined by experience.

Allowing for the features of the optical resonator according to the invention, these amplifiers would operate with a relatively low gain but with optimum extraction of the energy deposited in the rod of this amplifier considering the fluence about 10 times greater than the saturation fluence of the material of this rod.

FIG. 5 shows a diagrammatic view of a pulse optical resonator according to the invention. It is composed like any one of resonators 2, 4 and 6 and thus comprises structures 36a and 36b and mirrors 42 and 44, the polarisation rotator 46 and/or the lens 46a and the means of triggering pulses 50 and 52 that will be described later.

In one variant embodiment, a light amplifier 36c is placed at the output from this optical resonator.

This amplifier 36c comprises a single pass laser-rod 38c pumped by a set of laser diodes 40c operating continuously.

Control means 18 are then provided to control this amplifier 36c. This amplifier is substantially identical to the structures 36a and 36b and its laser rod 38c is preferably made from the same laser material as the laser rods 38a and 38b.

This laser material is chosen from among Nd:YAG (the preferred material), Nd:YLF, Nd:YALO, Yb:YAG, Nd:ScO₃ and Yb:Y₂O₃.

With reference once again to FIG. 4, each optical resonator is delimited by a first highly reflecting mirror 42 (reflection coefficient R equal to 100%, for example at 1064 nm) and a second mirror 44 that is partially reflecting (R of the order of 70% to 80%) to allow the light beam generated by this optical resonator to pass through it.

These mirrors are preferably curved and their radii of curvature are calculated so that the divergence of the beam is small, and such that the parameter M² is equal to about 10.

Furthermore, the length of the cavity is chosen as a function of the duration of the pulses.

The two curved mirrors may be replaced by two sets each comprising a divergent lens and a plane mirror.

Preferably, identical pumping structures are used in each of the lasers 2, 4 and 6 to compensate for the different thermal effects that can occur. But in this case, it is better to use a 90° polarisation rotator 46 at any location between the two laser rods 38a and 38b.

Instead of the rotator 46, a slightly divergent lens 46a could be used at exactly the mid path between the two rods.

As a variant, this lens in this arrangement and the rotator 46 could be used, the rotator still being located between the two rods adjacent to the lens.

The diameter of these laser rods is between 3 mm and 6 mm.

We use 4 mm diameter rods made of Nd:YAG doped at 1.1% in our experiments.

Furthermore, in the example in FIG. 4, each Nd YAG rod is pumped by 40 laser diodes, each of these diodes having a power of 30 W and emitting at 808 nm.

Each rod is preferably pumped homogeneously, in order to minimise spherical aberrations.

In order to make each laser pulsed, acousto-optic pulse triggering means are placed in the cavity on the path of the beam, at the location at which it diverges least, in other words between each of the rods and the polarisation rotator, to enable triggering of these pulses at a high rate.

Each of these acousto-optic triggers or Q-switches uses a silica crystal operating in compression mode with a radio frequency power of 90 W at 27 MHz, this power being applied on the crystal by a 4 mm transducer.

In the example in FIG. 4, two acousto-optic deflectors 50 and 52 of the type defined above are used, and are controlled by control means 18 located in the space delimited by the laser rods 38a and 38b on each side of the polarisation rotator 46.

These two acousto-optic deflectors 50 and 52 are used to block the cavity with gains corresponding to the average power mentioned above.

The control means 18 trigger operation of the EUV source to adapt its characteristics to the needs of microlithography. If applicable, they determine the simultaneousness of light pulses of lasers 2, 4 and 6 at the target.

If the optical paths have significantly different lengths, in particular they will be capable of compensating for these differences and managing triggering of all acousto-optic deflectors contained in the device in FIG. 4 so that synchronism is achieved for light pulses.

The control means 18 comprise:
means (not shown) of generating pumping laser diode power supply currents 40a and 40b (and possibly 40c) and
means (not shown) of generating modulated radio frequency currents, to control each pair of acousto-optic deflectors 50 and 52 almost synchronously, the offset between these deflectors preferably being less than 1 ns.

Furthermore, these control means 18 are designed to control lasers 2, 4 and 6 as a function of the plasma radiation measurement signals (generated by the interaction of laser beams with the target 16), supplied by one or several appropriate sensors such as the sensor 54, for example one or several fast silicon photodiodes with spectral filtering; for EUV radiation, this filtering may be done by zirconium, and by a molybdenum-silicon multilayer mirror, possibly doubled up; if the plasma growth rate is observed, either this filtering should be modified, or one or several other fast photodiodes with filtering closer to the visible spectrum should be added.

Control means 18 are also provided to control lasers 2, 4 and 6 as a function of:
signals for measuring the energy of light pulses from lasers 2, 4 and 6, that are provided by appropriate sensors 56, 58 and 60 respectively, for example fast silicon photodiodes with integrating means, and
signals for measuring the time shapes of light pulses from lasers 2, 4 and 6, signals that are provided by three appropriate sensors 62, 64 and 66 respectively, for example fast silicon photodiodes that may be the same sensors as sensors 56, 58 and 60, except that the signal is then taken off on the input side of the integration means.

Note that the optical means composed of the deflection mirrors 14 and the achromatic focusing doublets 20, 22 and 24 are chosen to enable spatial superposition with position fluctuations smaller than a low percentage, for example of the order of 1% to 10%, of the diameter of the focal spot (point P).

The laser device in FIG. 4 also comprises means designed to modify the spatial distribution of the pulse resulting from the addition of light pulses emitted by lasers 2, 4 and 6 respectively. These means, symbolised by arrows 74, 76 and 78 may for example be designed to displace achromatic doublets 20, 22 and 24, so as to modify the sizes of the focal spots output by each of these doublets respectively.

The control means 18 may be designed to shift the light pulses emitted by lasers 2, 4 and 6 with respect to each other in time, by shifting the triggering of lasers with respect to each other in an appropriate manner.

Note that the laser device in FIG. 4 is not polarised, unlike other known laser devices, for example as described in document [5].

Maintaining polarisation with Nd:YAG based lasers is difficult and makes the device more complicated. However, the modular design of the invention with spatial multiplexing means that it is not essential for the laser device to be polarised.

If higher repetition rates are required, greater than or equal to 10 kHz, it is preferable to avoid using variants with time multiplexing. Pulses derived from N lasers (for example N=10) then reach the target at exactly the same time.

One variant embodiment of the invention is diagrammatically and partially shown in FIG. 6. In this variant, spatial multiplexing of the laser beams 8, 10 and 12 is used before they are focused on the target P.

This is done by replacing the last two mirrors 14 (top of FIG. 4) that are associated with the beams 10 and 12, by two drilled mirrors 80 and 82 aligned with the last mirror 14 (top of the FIG. 4) associated with beam 8.

Thus, the drilled mirror 80 allows part of the beam 8 to pass through the target and reflects part of the beam 10 towards the target. A means of stopping the beam 84 is provided to stop the rest of the beam 10 (not reflected towards the target).

Similarly, the drilled mirror 82, in which the drilling is larger than the drilling in the mirror 80, allows part of the beams 8 and 10 to pass through towards the target and reflects part of the beam 12 towards this target. A means of stopping the beam 86 is provided to stop the rest of the beam 12 (not reflected towards the target).

An achromatic focusing doublet 88 is designed to focus the beams output from the aligned mirrors 14, 80 and 82 onto the target.

Another variant embodiment of the invention is diagrammatically and partially shown in FIG. 7. In this variant, the drilled mirror 80 may be replaced by a sharp edged mirror 90 designed to reflect part of the beam 8 towards this target. A means of stopping the beam 94 is provided to stop the rest of the beam 10 (not reflected towards the target).

The drilled mirror 82 is also replaced by another sharp edged mirror 92 designed to reflect part of the incident beam 12 towards the target, allowing part of the beams 8 and 10 to pass at its periphery towards this target. A means of stopping the beam 96 is provided to stop the remainder of the beam 12 (not reflected towards the target).

Achromatic focusing doublets 20, 22, 24 and 88 are advantageously designed to minimise aberrations. But they may be replaced by curved mirrors.

1-17. (canceled)

18. An optical resonator with a solid state amplifying medium, the optical resonator being pulsed and pumped by diodes operating continuously, and comprising:
at least two laser rods;
at least one means for triggering light pulses, the means for triggering located in a part of the optical resonator in which a laser beam generated by the optical resonator diverges least; and
first and second mirrors that delimit a cavity of the optical resonator, the first mirror being reflecting and the second mirror being partly reflecting.

19. An optical resonator according to claim 18, wherein the at least two laser rods comprise isotropic material of Nd:YAG or Yb:YAG, and the cavity comprises means for polarization rotation on a path of the laser beam in each of spaces formed by two successive of the at least two rods, the rotation being 90°.

20. An optical resonator according to claim 18, further comprising a divergent lens, in a middle of each interval between two adjacent rods of the at least two rods.

21. An optical resonator according to claim 18, wherein a laser material from which the at least two laser rods are made is chosen from the group comprising Nd:YAG, Nd:YLF, Nd:YALO, Yb:YAG, Nd:ScO₃, and Yb:Y₂O₃.

22. An optical resonator according to claim 18, comprising two rods made of a laser material, substantially identical, and means for polarization rotation placed in an area between the two rods.

23. An optical resonator according to claim 20, wherein the means for triggering pulses placed in each pulsed optical resonator comprises two Q-switches located in the interval, on each side of the means for polarization rotation, between the means for polarization rotation and the at least two laser rods.

24. An optical resonator according to claim 19, wherein the means for triggering are of acousto-optical type.

25. An optical resonator according to claim 18, associated with one or plural single pass amplifiers.

26. A laser device, comprising:
at least three pulsed optical resonators according to claim 18; and
means for transferring light pulses to substantially a same location on a target and at substantially a same time at the location; and
means for controlling the at least three pulsed optical resonators, so that all means for triggering forming part of the device operate synchronously.

27. A device according to claim 26, comprising at least ten pulsed optical resonators in parallel.

28. A device according to claim 26, wherein the means for transferring light pulses comprises means for transferring the light pulses onto the target along a same path.

29. A device according to claim 26, further comprising means for modifying a spatial distribution of a light pulse resulting from addition of light pulses output by the at least three optical resonators.

30. A device according to claim 26, wherein the means for controlling the at least three pulsed optical resonators also are for modifying a time distribution of a light pulse resulting from addition of light pulses supplied by the at least three optical resonators, to create composite pulses.

31. A device according to claim 30, wherein a profile of each composite pulse comprises a first plasma ignition pulse created by interaction of the light pulses with the target, wherein a time interval in which the light energy output by the laser is minimum during plasma growth, and wherein a second pulse is composed of plural elementary pulses according to a sequence that depends on plasma growth.

32. A device according to claim 26, further comprising means for modifying a recurrence rate of light pulses emitted by the at least three optical resonators or a sequence of the light pulses emitted by the at least three optical resonators.

33. A device according to claim 30, capable of sending a first highly focused beam onto the target and then applying a remainder of the light energy onto the target with broader focusing.

34. A device according to claim 26, wherein the target is configured to output light in an extreme ultraviolet domain by interaction with the light pulses emitted by the at least three optical resonators.
